(19) United States
(12) Patent Application Publication
(10) Pub. No.: US 2024/0377288 A1
(43) Pub. Date: Nov. 14, 2024

(54) DEVICE FOR TAKING A SAMPLE OF GAS

(71) Applicants: AIR LIQUIDE FRANCE INDUSTRIE, Paris (FR); L'Air Liquide Société Anonyme pour l'Etude et l'Exploitation des Procédés Georges Claude, Paris (FR)

(72) Inventors: Claire BLONDEEL, Les Loges-en-Josas (FR); Yann LESCORNEZ, Les Loges-en-Josas (FR); Nathalie CHRAMOSTA, Les Loges-en-Josas (FR); Gilles PINTE, Les Loges-en-Josas (FR)

(21) Appl. No.: 18/293,100

(22) PCT Filed: Jul. 29, 2021
(86) PCT No.: PCT/EP2021/071276

§ 371 Date: Jan. 29, 2024

(51) Int. Cl. G01N 1/22; F17C 13/02; F17C 13/04; G01M 3/28

(52) U.S. Cl. CPC G01N 1/2226; F17C 13/025; F17C 13/04; G01M 3/2815; F17C 2205/0338; F17C 2221/012; F17C 2223/036; F17C 2250/046; F17C 2265/066; G01N 2001/2229

(57) ABSTRACT

A device for taking a sample of gas, including a base supporting a fluid circuit, a sampling tank and a first pipe connecting the inlet connector to an inlet of the sampling tank, the first pipe having a set of valves for controlling the circulation of the gas, the circuit having an evacuation line with a control valve and includes a downstream end that opens into the atmosphere, the circuit has a second pipe and includes an analysis line having an upstream end connected to the first pipe and a downstream end provided with an analysis outlet intended to be connected to an analysis apparatus, the analysis line having at least one control valve, and wherein the outlet of one housing is connected directly to the inlet of the adjacent housing.

### CROSS REFERENCE TO RELATED APPLICATIONS

This application is a 371 of International Application No. PCT/EP2021/071276, filed Jul. 29, 2021, the entire contents of which are incorporated herein by reference.

### BACKGROUND

The invention relates to a device for taking a sample of gas.

The invention relates more particularly to a device for taking a sample of gas, in particular for a hydrogen tank filling station, comprising a base supporting a fluid circuit comprising a first, upstream end provided with an inlet connector intended to be connected removably to an outlet connector of a source of gas to be sampled, the circuit comprising a sampling tank and a first pipe connecting the inlet connector to an inlet of the sampling tank, the first pipe comprising a set of a plurality of valves for controlling the circulation of the gas, which are disposed in series, the circuit comprising an evacuation line which is provided with a control valve and comprises a first, upstream end connected to the first pipe and a second, downstream end that opens into a discharge zone such as the atmosphere, the circuit comprising a second pipe having an upstream end connected to an outlet of the sampling tank and a downstream end connected to the evacuation line via a control valve, the circuit comprising an analysis line comprising an upstream end connected to the first pipe and a downstream end provided with an analysis outlet intended to be connected to an analysis apparatus, the analysis line comprising at least one control valve.

According to the publication of the standard ISO 14687, owners of hydrogen fuel stations in France or in Europe need to periodically check the quality of their gas at the point of use (outlet nozzle).

Plates are known for carrying out the sampling and analysis of the sample.

A plate used by the applicant uses a tank (or cylinder) provided for sampling by compression/expansion or by dilution or flushing. This tank has a dip tube: the gas passes in at an inlet in the valve and is transferred to the bottom of the tank by the dip tube and exits again at an outlet of the valve.

The known sampling devices have deficiencies, for example: a relatively large bulk, risks of leaks, a poorly adaptable structure.

Moreover, improving ergonomics and safety is a constant objective.

### SUMMARY

An aim of the present invention is to overcome all or some of the drawbacks of the prior art that are set out above.

To this end, the device according to the invention, which is otherwise in accordance with the generic definition thereof given in the above preamble, is essentially characterized in that at least some of the control valves of the circuit are disposed in respective housings that each comprise a fluid inlet and a fluid outlet that are connected to said control valve, the outlet of one housing being connected directly to the inlet of the adjacent housing.

Furthermore, embodiments of the invention may have one or more of the following features:
the fluid circuit also comprises at least one manometer, said manometer also being disposed in a respective housing, each of which comprises a fluid inlet and a fluid outlet to said manometer, the inlet of the housing of the manometer being connected directly to the outlet of the housing of an adjacent control valve and the outlet of the housing of the manometer being connected directly to the inlet of an adjacent housing of another control valve,
all the control valves of the circuit and the at least one manometer are disposed in respective housings that each comprise a fluid inlet and a fluid outlet that are connected to said control valve, the corresponding inlets and outlets of said housings being connected directly in series,
the housings are modular and parallelepipedal, in particular cubic, and have orifices in at least two different faces and preferably in four different faces,
at least one housing contains a valve for controlling the circulation of the gas or a manometer and comprises three orifices situated in three different faces, said orifices being directly connected respectively to the inlet or outlet of three adjacent housings,
the first pipe comprises, disposed in series between the inlet connector and the inlet of the reservoir: a first isolation valve, a first flow regulator, a manometer, a second isolation valve,
the second pipe comprises, between the outlet of the sampling tank and its downstream end connected to the evacuation line: an isolation valve,
the analysis line comprises, disposed in series between its upstream end and its downstream end: a pressure regulator and a fifth isolation valve,
the circuit comprises a vent valve shutter connected to the first pipe and to the second pipe, said vent valve shutter also being situated in a respective housing that comprises a fluid inlet and a fluid outlet and is connected directly to the inlet/outlet of at least one adjacent housing,
the first pipe comprises a first flexible portion connecting an outlet of a housing and the inlet of the sampling tank, said first flexible portion being attached to said support via a holding member such as a whip check cable,
the second pipe comprises a second flexible portion connecting the outlet of the sampling tank to an inlet of a housing, said second flexible portion being attached to said support via a holding member such as a whip check cable.

The invention may also relate to any alternative device or method comprising any combination of the features above or below within the scope of the claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows a transparent top view schematically illustrating the structure and operation of the sampling device according to one exemplary embodiment of the invention,

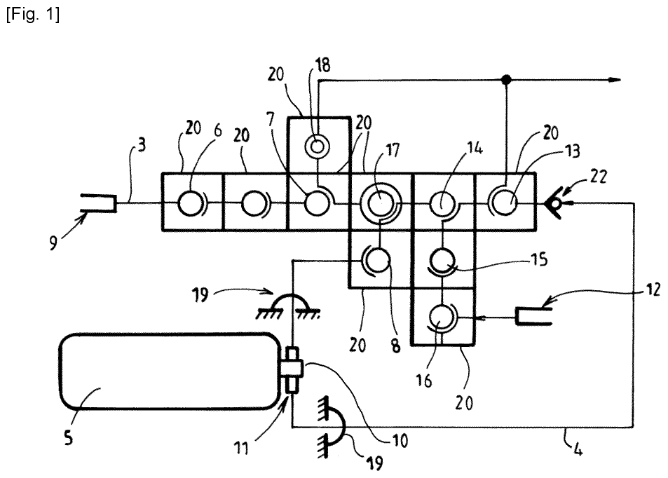

FIG. 2 shows a transparent top view schematically illustrating the structure and operation of the sampling device in another configuration.

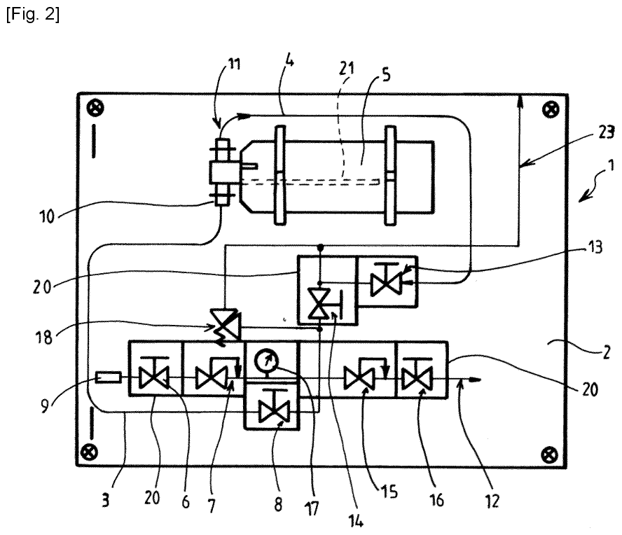

### DETAILED DESCRIPTION OF THE PREFERRED EMBODIMENTS

The device 1 for taking a sample of gas, in particular for a hydrogen tank filling station, comprises a base 2 forming a support for a fluid circuit 3, 4. This circuit comprises a first, upstream end provided with an inlet connector 9 intended to be connected removably to an outlet connector of a source of gas to be sampled (typically an outlet nozzle of a filling station).

The circuit 3, 4 comprises a sampling tank 5 and a first pipe 3 connecting the inlet connector 9 to an inlet 10 of the sampling tank 5 (at a valve for example). The tank 5 is preferably strapped to the base 2.

The first pipe 3 comprises a set of a plurality of valves 6, 7, 8 for controlling the circulation of the gas and accessories disposed in series. In this example, the first pipe 3 comprises, disposed in series in this order between the inlet connector 9 and the inlet 10 of the reservoir 5: a first isolation valve 6, a first flow regulator 7 (pressure regulator), a downstream manometer 17 and a second isolation valve 8.

Preferably, the inlet 10 of the sampling tank 5 leads the gas towards the bottom of the tank via a dip tube 21. The introduced gas can exit again on the opposite side via an outlet 11 preferably at the same valve.

The circuit comprises an evacuation line 23, which is provided with a control valve 14 and comprises a first, upstream end connected to the first pipe 3 (preferably between the first flow regulator 7 and the second isolation valve 8). The evacuation line 23 comprises a second, downstream end that opens into a discharge zone such as the atmosphere.

The circuit comprises a second pipe 4 having an upstream end connected to the outlet 11 of the sampling tank 5 and a downstream end connected to the evacuation line 23 via a control valve 13. Preferably, this downstream end of the second pipe 4 is connected between the control valve 14 and the second, downstream end of the evacuation line 23.

The circuit also comprises an analysis line comprising an upstream end connected to the first pipe 3 (downstream of the first flow regulator 7) and a downstream end provided with an analysis outlet 12 intended to be connected to an analysis apparatus. This analysis line may comprise, disposed in series: a second pressure regulator 15 and a fifth isolation valve 16.

The second pipe 4 therefore comprises a set of valves 13 and possible accessories for controlling the circulation of the gas, which are disposed in series.

The first isolation valve 6 and the second isolation valve 8 make it possible to isolate the circuit from the inlet 10 of the sampling tank 5 (and may be used for filling by compression/expansion or filling by dilution or flushing).

The third isolation valve 13 makes it possible to isolate the outlet 11 of the sampling tank 5. This valve 13 is preferably used only to effect filling by dilution or flushing.

The second pressure regulator 15 of the analysis line makes it possible to regulate the pressure in order to supply one or more analysers connected to the analysis outlet 12. The fifth isolation valve 16 makes it possible to isolate the circuit from the downstream analysers.

At least some and preferably all of the valves and accessories for controlling the circulation of the gas are disposed in respective housings 20 that each comprise at least one fluid inlet and one fluid outlet that are connected. For the adjacent elements (valves, accessories) in series, the outlet of one housing 20 is connected directly to the inlet of the adjacent housing 20.

The housings are for example identical modules that are parallelepipedal, in particular cubic, and have orifices in at least two different faces and preferably in three or four different faces.

The housings which have the members (valves, etc.) may be for example of the types described in the document WO9857078A1, WO05008107A2, WO9825058A1 or WO19025734A1.

In particular, each housing 20 may have an internal compartment which receives the fluidic member (valve, manometer, pressure regulator and/or flow regulator or the like) and a system of channels which connects the internal fluidic member to orifices in the faces of the housing 20 in order to receive or distribute the fluid. The housings 20 are assembled in a sealed manner face to face by fixing members, without the need for intermediate ducts.

The circuit 4, 5 of the device 1 preferably comprises a vent valve shutter 18 connected to the first pipe 3 (for example between the downstream side of the first pressure regulator 7 and the fourth isolation valve 14) and to the evacuation line 23, in order to evacuate the gas in the event of an abnormal overpressure. The vent valve shutter 18 may also be situated in a respective housing 20 that comprises a fluid inlet and a fluid outlet and is connected directly to the inlet/outlet of at least one adjacent housing 20.

A restriction (not shown) may be provided between the control valve 14 and the vent line 23.

The vent valve shutter 18 (relief valve) may be calibrated to 200 bar for example to avoid excessively high pressures (filling pressure greater than 600 bar for example) in the circuit and in the sampling tank 5.

The end of the evacuation line 23 is preferably connected to a vent or to an evacuation chimney for example.

The first pipe 3 may comprise a first flexible portion connecting an outlet of a housing 20 to the inlet 10 of the sampling tank 5. Advantageously, this first flexible portion is attached to the support 2 via a holding member 19 such as a whip check cable.

In the same way, the second pipe 4 may comprise a flexible portion connecting the outlet 11 of the sampling tank 5 to an inlet of a housing 20, and this second flexible portion may also be attached to the support 2 via a holding member 19 such as a whip check cable. This improves the safety of the device 1.

The holding whip check cables 19 have been schematically depicted but could be fixed to anchoring points at the edge of the base 2. In addition, during the transport of the base, the ends of the hoses may be connected to stoppers to hold them and protect the quick connectors from bad weather.

The base 2 may comprise a rigid plate mounted on deformable feet. Handles may be provided to allow the base 2 to be transported.

The confinement of the members (valves, manometer, pressure regulator, etc.) in respective modular housings 20 that are attached directly together (by nesting or the like) reduces the circuitry and the risks of leaks in particular during transport (vibrations).

The members and their association are more compact.

The analysis outlet 12 makes it possible to carry out analyses on side (by connecting an analysis apparatus thereto).

This device 1 makes it possible to take samples of hydrogen without it being necessary to fill a vehicle at the same time.

The filling of the sampling tank 5 may be effected by compression/expansion or by dilution or flushing.

Before a sampling tank 5 is filled, it is necessary to carry out leak tests for safety and quality reasons during sampling.

For example, two leak tests at two different pressures can be carried out (40 bar and 180 bar for example).

An empty sampling tank 5 is connected to the circuit. The gas outlet hose is not used and may remain connected to a protective stopper.

Leak tests on the connectors between the inlet connector 9 and the closed first isolation valve 6 may be carried out.

This first isolation valve 6 may then be opened (gradually) and leak tests may be carried out for example as far as the first pressure regulator 7. Then, the latter may be opened and adjusted to this same pressure of 40 bar (measured by the downstream manometer 17). The second isolation valve 8 may be opened (the sampling tank 5 remaining closed, the third isolation valve 13 and fourth isolation valve 14 and fifth isolation valve 16 also being closed).

All the connectors (valves, manometer, etc.) may thus be tested.

If the leak tests are conclusive, the pressure delivered by the first pressure regulator 7 may be increased for example to 180 bar (below the value at which the vent valve shutter 18 opens). Further leak tests can be carried out at this second pressure.

Once said tests have been carried out and are conclusive, it is possible to take the sample of hydrogen, for example analyses (water) for ensuring the quality of sampling. Of course, it is also possible to analyse other elements such as oxygen, for example.

Several (in particular ten) compression/expansion cycles of all the lines of the circuit can be carried out before the hydrogen is injected into the sampling tank 5.

At the same, the dew point may be measured to ensure the proper drying of the lines (H2O<−70° C.).

For the compression of the circuit (180 bar for example), the first isolation valve 6 is opened. In the case of analysis, the fifth isolation valve 16 is opened.

For the expansion of the lines of the circuit, the second isolation valve 8 is closed and the fourth isolation valve 14 is opened gradually and it may be expected that the pressure will drop to around 10 bar.

When the lines of the circuit are at a pressure of about 10 bar, the fourth isolation valve 14 may be closed and the first isolation valve 6 may be opened. When the pressure reaches 180 bar in the circuit, the first isolation valve 6 may be closed again and the fourth isolation valve 14 opened until 10 bar is reached again.

These increases and drops in pressure can be repeated, for example ten times, to ensure effective drainage of the lines of the circuit.

If a water analyser 26 is connected to the analysis outlet 12, it is necessary to reach a dew point below −70° C. (as a function of the response time of the corresponding sensor).

Humidity is an impurity present mostly in hydrogen filling stations in particular. The presence of water may make the sample non-compliant with the hydrogen quality standard, making its analysis or measurement preferably systematic during hydrogen sampling.

Therefore, it is not necessary to analyse all of the constituents of the standard if the humidity is above its acceptable maximum value. The analysis of the latter therefore avoids pointless and non-compliant sampling.

The first isolation valve 6 may be opened and the fourth isolation valve 14 closed.

With the lines having been correctly drained, it is possible to fill the sampling tank 5. The first isolation valve 6 may be opened, as may the inlet valve 10 of the sampling tank 5 until the pressure has stabilized at, for example, 180 bar.

The temperature of the body of the tank 5 needs to increase (thereby confirming the filling of the tank 5).

Once the pressure is stable (180 bar), following a delay time (for example about one minute), the first isolation valve 6 may be closed and the fourth isolation valve 14 opened. The pressurized gas is evacuated via the evacuation line 23. When the pressure in the circuit drops below around 10 bar again, the fourth isolation valve 14 may be closed.

The first isolation valve 6 and the second isolation valve 8 may be opened gradually to fill the sampling tank 5 again.

This operation may be repeated, for example ten times, and the final time, the pressure in the sampling tank 5 may be stabilized at 180 bar for example.

The valve is closed (inlet 10) and the first isolation valve 6 is closed. Sampling is carried out.

The fourth isolation valve 14 may be opened in order to lower the pressure in the circuit.

For sampling by dilution, the same steps of leak tests, of pressurization and of expansion as above may be used (including for the circuit connected to the outlet 11 of the sampling tank 5).

For a cycle of flushing the sampling tank 5, the first isolation valve 6 may be opened, as may the third isolation valve 13 (the opening of the third isolation valve 13 evacuates the flow of gas towards the evacuation line 23).

Alternatively, compression/expansion cycles may be carried out by acting on the first isolation valve 6 and the third isolation valve 13 (emptying of the tank 5).

Following a given duration of flushing the tank 5 (for example a half-hour), the outlet valve 11 of the sampling tank 5 may be closed, followed by the inlet valve 10. Sampling is carried out.

The first isolation valve 6 is closed. The third isolation valve 13 remains open in order to release the pressure in the entire circuit for a given time (a few minutes, for example). This drains the sampling line.

Then, all the valves and pressure regulators can be closed.

The procedure which makes it possible to measure the humidity in order to determine if it is necessary, without risks of damage, to carry out the sampling is described above and below.

This procedure preferably uses an abovementioned device, but it may be applied to other sampling devices.

Leak tests are first of all carried out at low pressure (for example 40 bar) and, if they are conclusive, these tests can be repeated at a higher pressure (for example 180 bar).

The humidity analyser 26 connected to the outlet 12 checks the humidity level in the sampling circuit before sampling.

Several (for example ten) compression/expansion cycles of all the lines of the circuit are carried out before the humidity analysis and before sampling in the tank 5.

For the compression of the circuit (180 bar for example), the first isolation valve 6 and the second isolation valve 8 are opened. The fourth isolation valve 14, the fifth isolation valve 16 and the inlet valve 10 of the tank 5 are closed.

For the expansion of the lines of the circuit, the first isolation valve 6 is closed and the fourth isolation valve 14 is opened gradually and it may be expected that the pressure will drop to around 10 bar.

When the lines of the circuit are at a pressure of about 10 bar, the fourth isolation valve 14 may be closed and the first isolation valve 6 may be opened. When the pressure reaches 180 bar in the circuit, the first isolation valve 6 may be closed again and the fourth isolation valve 14 opened until 10 bar is reached again.

These increases and drops in pressure can be repeated, for example ten times, to ensure effective drainage of the lines of the circuit.

The first isolation valve 6 may be opened and the fourth isolation valve 14 and the second isolation valve 8 are closed.

At the same time, the fifth isolation valve 16 may be opened in order that the gas to be sampled is analysed by the humidity analyser installed at the outlet 12.

If, after sufficient flushing, the humidity analysis 26 provides a result non-compliant with the standard (above a predetermined threshold), the user may be asked if they wish to take a sample all the same in order to check for other impurities or if they wish to correct the fault before taking the sample.

If, after sufficient flushing, the humidity analysis 26 provides a result compliant with the standard (ISO standard for example; the standards being liable to change), it is possible to drain the sampling tank 5.

For the compression of tank 5 (180 bar for example), the first isolation valve 6, the second isolation valve 8 and the inlet valve 10 of the tank 5 are opened. The fourth isolation valve 14 and the fifth isolation valve 16 are closed.

For the expansion of the lines of the circuit, the first isolation valve 6 is closed and the fourth isolation valve 14 is opened gradually and it may be expected that the pressure will drop to around 10 bar.

This increases and drops in pressure may be repeated, for example ten times, and the final time, the pressure in the tank 5 may be stabilized at 180 bar.

The inlet valve 10 of the tank 5 is closed and the first isolation valve 6 is closed. Sampling is carried out.

The fourth isolation valve 14 may be opened in order to lower the pressure in the circuit with draining via the line 23 and to allow the sampling tank 5 to be disconnected.

In addition, as illustrated, the fluid circuit preferably comprises an upstream manometer 24 disposed in a housing 20 which comprises an inlet connected (preferably directly) to the inlet connector 9 and an outlet connected directly to the inlet of an adjacent housing 20 of another control valve 6. This upstream manometer 24 is preferably configured to measure the pressure in a range of 0 to 1000 bar.

In addition, as illustrated, this first housing 20 may have a second inlet forming an inlet connector 25 (for gas at a lower pressure, for example).

This makes it possible to take samples at relatively high pressure for hydrogen stations operating at 350 or 700 bar with the inlet connector 9 and by visualizing the pressure with the manometer 24. In the same way, this device may sample gas at a lower pressure via the other inlet 25 on circuits of a hydrogen station or production factory with the inlet connector 25 and by visualizing the pressure with the manometer 24.

The method for taking a sample of gas preferably uses the abovementioned device.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-15. (canceled)

16. A device for taking a sample of gas, the device comprising:
a base supporting a fluid circuit comprising a first, upstream end provided with an inlet connector configured to be connected removably to an outlet connector of a source of gas to be sampled,
the fluid circuit comprising:
a sampling tank and a first pipe connecting the inlet connector to an inlet of the sampling tank,
the first pipe comprising a set of a plurality of valves, disposed in series, for controlling the circulation of the gas,
an evacuation line which is provided with a control valve and comprises a first, upstream end connected to the first pipe and a second, downstream end that opens into a discharge zone such as the atmosphere,
a second pipe having an upstream end connected to an outlet of the sampling tank and a downstream end connected to the evacuation line via the control valve, and
an analysis line comprising an upstream end connected to the first pipe and a downstream end provided with an analysis outlet configured to be connected to an analysis apparatus,
the analysis line comprising at least one control valve,
wherein at least some of the control valves of the circuit are disposed in respective housings that each comprise a fluid inlet and a fluid outlet that are connected to said control valve, and,
wherein the outlet of one housing is connected directly to the inlet of the adjacent housing.

17. The device according to claim 16, wherein the fluid circuit further comprises at least one downstream manometer, said downstream manometer also being disposed in a respective housing, each of which comprises a fluid inlet and a fluid outlet to said downstream manometer, and in that the inlet of the housing of the downstream manometer is connected directly to the outlet of the housing of an adjacent control valve and the outlet of the housing of the manometer is connected directly to the inlet of an adjacent housing of another control valve.

18. The device according to claim 16, wherein the fluid circuit further comprises an upstream manometer, said upstream manometer also being disposed in a respective housing, each of which comprises a fluid inlet and a fluid outlet to said upstream manometer, and in that the inlet of the housing of the upstream manometer is connected directly to the inlet connector and the outlet of the housing of the upstream manometer is connected directly to the inlet of an adjacent housing of another control valve.

19. The device according to claim 18, wherein the housing of the upstream manometer comprises a second inlet configured to be connected to a pressurized gas source.

20. The device according to claim 16, wherein all the control valves of the circuit and the at least one manometer are disposed in respective housings that each comprise a fluid inlet and a fluid outlet that are connected to said control valve, and in that the corresponding inlets and outlets of said housings are connected directly in series.

21. The device according to claim 16, wherein the housings are modular and parallelepipedal, and have orifices in at least two different faces.

22. The device according to claim 16, wherein at least one housing contains a valve for controlling the circulation of the gas or a manometer and comprises three orifices situated in three different faces, said orifices being directly connected respectively to the inlet or outlet of three adjacent housings.

23. The device according to claim 16, wherein the first pipe comprises, disposed in series between the inlet connector and the inlet of the reservoir: a first isolation valve, a first flow regulator, at least one manometer, a second isolation valve.

24. The device according to claim 16, wherein the second pipe comprises, between the outlet of the sampling tank and the downstream end connected to the evacuation line: an isolation valve.

25. The device according to claim 16, wherein the analysis line comprises, disposed in series between its upstream end and the downstream end: a pressure regulator and a fifth isolation valve.

26. The device according to claim 16, wherein the circuit comprises a vent valve shutter connected to the first pipe and to the second pipe, said vent valve shutter also being situated in a respective housing that comprises a fluid inlet and a fluid outlet and is connected directly to the inlet/outlet of at least one adjacent housing.

27. The device according to claim 16, wherein the first pipe comprises a first flexible portion connecting an outlet of a housing and the inlet of the sampling tank said first flexible portion being attached to said support via a holding member such as a whip check cable.

28. The device according to claim 16, wherein the second pipe comprises a second flexible portion connecting the outlet of the sampling tank to an inlet of a housing, said second flexible portion being attached to said support via a holding member such as a whip check cable.

29. The device according to claim 16, further comprising a water analyzer connected to the analysis outlet.

30. A method for taking a sample of gas, the method using a device for taking a sample of gas, comprising:
a base supporting a fluid circuit comprising a first, upstream end provided with an inlet connector configured to be connected removably to an outlet connector of a source of gas to be sampled,
the fluid circuit comprising:
a sampling tank and a first pipe connecting the inlet connector to an inlet of the sampling tank,
the first pipe comprising a set of a plurality of valves for controlling the circulation of the gas, which are disposed in series, the circuit comprising an evacuation line which is provided with a control valve and comprises a first, upstream end connected to the first pipe and a second, downstream end that opens into a discharge zone such as the atmosphere,
a second pipe having an upstream end connected to an outlet of the sampling tank and a downstream end connected to the evacuation line via the control valve,
an analysis line comprising an upstream end connected to the first pipe and a downstream end provided with an analysis outlet connected to an analysis apparatus,
the analysis line comprising at least one control valve (16),
wherein the method comprises:
a step of carrying out leak tests, during which the circuit is pressurized and the pressure is measured,
a step comprising a plurality of compression/expansion cycles of the lines of the circuit,
a step of measuring the humidity of the gas to be sampled and,
a step of sampling gas to be analysed in the tank.
